(19) United States
(12) Patent Application Publication
(10) Pub. No.: US 2017/0102309 A1
(43) Pub. Date: Apr. 13, 2017

(54) METHOD FOR ACTUATING AN ELECTRIC MOTOR AND CONFIGURATION FOR EXERTING OSCILLATORY ROTATION OF A DRIVESHAFT

(71) Applicant: ANTON PAAR GMBH, Graz-Strassgang (AT)

(72) Inventors: SIEGFRIED HUCK, MANNHEIM (DE); JOERG LAEUGER, STUTTGART (DE); HEIKO STETTIN, OSTFILDERN (DE)

(21) Appl. No.: 15/285,677

(22) Filed: Oct. 5, 2016

(30) Foreign Application Priority Data
Oct. 8, 2015 (AT) A50864/2015

(51) Int. Cl. G01N 11/16; H02P 21/14

(52) U.S. Cl. CPC G01N 11/162; H02P 21/14; G01L 3/22

(57) ABSTRACT

A method for actuating an electric motor for a rheometer includes transferring drive energy to a sample. A time profile for deflection is periodic, a value for deflection is a measured variable, the motor is actuated by a manipulated variable, the measured and manipulated variables are mutually nonlinear, an approximation function for the time profile is a weighted sum of base functions, weights for base functions are a parameter vector, the manipulated variable is a weighted sum of base functions. The measured variable is sampled, sampled values are used within a time window, an approximation function for sampled values is a weighted sum of base functions, the weights are an actual parameter vector, a difference between intended and actual parameter vectors is subtracted from the manipulated parameter vector, the manipulated variable is a weighted sum of base functions and values of a new manipulated parameter vector are used as weights.

### CROSS-REFERENCE TO RELATED APPLICATION

This application claims the priority, under 35 U.S.C. §119, of Austrian Patent Application AT A50864/2015, filed Oct. 8, 2015; the prior application is herewith incorporated by reference in its entirety.

### BACKGROUND OF THE INVENTION

### Field of the Invention

The invention relates to a method for actuating an electric motor for an oscillatory rotation of a driveshaft, in particular for a rheometer. Furthermore, the invention relates to a configuration for exerting an oscillatory rotation of a driveshaft, in particular for a rheometer for measuring the viscosity of a sample.

The prior art has disclosed various closed-loop actuation controls for electric motors, which excite an electric motor to carry out an oscillatory rotation of the driveshaft. In particular, such methods are used to measure the nonlinear, rheological properties of media, wherein the driveshaft of the motor is brought into the region of a medium to be examined and, by moving the driveshaft in the relevant medium, the nonlinear, rheological properties of the latter are established. In that case, a rotating oscillation with large deflection amplitudes is particularly preferred since the used media or samples exhibit a nonlinear behavior when certain thresholds are exceeded by the employed deflection amplitudes. The prior art has disclosed, in particular, the practice of examining the deformation behavior under cyclical loads, in particular expansion and compression between two measuring parts, wherein at least one of the measuring parts is connected to the driveshaft of the motor. A so-called rotational rheometer which is thus embodied has shearing plates, between which the sample to be examined is disposed, wherein one of the shearing plates is connected to the driveshaft of the electric motor.

The prior art has disclosed rotational and oscillatory rheometers as instruments for determining the flow behavior of viscoelastic samples by using different trial positions, such as e.g. rotation, relaxation and oscillation trials. In the process, it is possible to examine both the flow behavior of liquids and the deformation behavior of solids. In general, real samples exhibit a combination of elastic and plastic behavior. The sample material to be examined is introduced into a measurement space between two measuring parts and the distance between the two measuring parts is determined by using a height adjustment and suitable sensors. The upper measuring part and lower measuring part are moved counter to one another in a relative manner about a common axis of rotation. The sample is exposed to a shearing load due to the rotation of the measuring parts against one another. Both rotating and rotating oscillatory movements are possible in such a measurement setup. In principle, different geometries can be used for such a trial setup, in particular measurement systems in which the medium is clamped between two plates, or measurement systems in which the medium is clamped between a cone and a plate, or measurement systems in which the medium is disposed between two concentrically disposed cylinders which rotate counter to one another.

The prior art disclosed various rheometers, in which the determination of the torque is effected by using a motor constructed for driving and determining torque. However, the torque can alternatively also be determined by way of two mutually separated units for driving and rotation, which are each assigned to one of the measurement parts. Moreover, devices with two measurement motors are also known, as emerge, for example, from Austrian Patent AT 508.706 B1, corresponding to U.S. Pat. No. 8,453,496 and U.S. Patent Application US 2007/0292004.

Independently of the type of motor, it is possible to use synchronous motors with permanent magnets, or else asynchronous motors, within the scope of the invention. The amplitude of the oscillatory motion, the oscillation frequency, the rotational speed of the motor or the torque acting on the sample may be predetermined within the scope of the invention.

In general, the torque can be measured by way of the power consumption of the respective electric motor, wherein there is a functional relationship with the power uptake of the motor for the torque, depending on the type of the motor or device being used: N=c₁×I, or N=c₂×I², where the two constants c₁ and c₂ are device specific.

The deflection of the oscillating motor can be established in different ways, in particular optically.

The goal of the measurement of a sample lies in obtaining different measurement values for different amplitudes, deflections and frequencies, which may be modified independently of one another. The measurement values thus established are referred to as a rheological fingerprint of the material to be examined.

However, the substantial problem existing is that the respective excitation is also modified by the nonlinear behavior of the medium or the sample.

### SUMMARY OF THE INVENTION

It is accordingly an object of the invention to provide a method for actuating an electric motor and a configuration for exerting oscillatory rotation of a driveshaft, which overcome the hereinafore-mentioned disadvantages of the heretofore-known methods and configurations of this general type and which develop an actuation of an electric motor for an oscillatory rotation, in which it is possible to set either the time profile of the torque or the time profile of the deflection freely in advance. In particular, it is an object of the invention for the time profile of the torque or of the deflection to assume the form of a sine oscillation or cosine oscillation with great accuracy. To this end, the invention proposes a specific actuation of the electric motor.

With the foregoing and other objects in view there is provided, in accordance with the invention, a method for actuating an electric motor for an oscillatory rotation of a driveshaft, in particular for a rheometer. Provision is therefore made for:
a) the electric motor to transfer the drive energy thereof to a sample which resists the oscillation of the electric motor,
b) an intended time profile, to be achieved, for the deflection or for the sample torque to be predetermined and for this intended time profile to have a periodic predetermined form,
c) the actual value for the deflection or for the sample torque to be established continuously as a measured variable,
d) the electric motor to be actuated by predetermining a manipulated variable in the form of the voltage applied thereon or the current flowing therethrough,
e) the measured variable and the manipulated variable to behave nonlinearly with respect to one another, at least within a region between the maximum and the minimum of the predetermined periodic intended time profile,
f) an approximation function to be established for the intended time profile as a weighted sum of a number of predetermined periodic base functions with a time offset where necessary, and for the used weights for the individual base functions to be established as an intended parameter vector,
g) the manipulated variable to be predetermined as a sum of the base functions weighted by manipulated parameters of a manipulated parameter vector, wherein, initially, the intended parameter vector multiplied by a predetermined factor is predetermined as manipulated parameter vector, and
the following steps h) to k) to be subsequently carried out continuously and repeatedly in accordance with a regulating process, as follows:
h) the measured variable is continuously sampled and the last established sampled values for the measured variable are used within a predetermined time window,
i) an approximation function is established for the sampled values of the measured variable within the time window as a weighted sum of the base functions, and the used weights for the individual base functions are established as an actual parameter vector,
j) a difference is established between the intended parameter vector and the actual parameter vector and this difference, possibly weighted by a further predetermined factor, is subtracted from the manipulated parameter vector, and
k) the subsequently used manipulated variable is predetermined as a weighted sum of the base functions, wherein the values of the newly generated manipulated parameter vector are used as weights in the subsequent steps h) to j).

With the objects of the invention in view, there is also provided a configuration for exerting oscillatory rotation of a driveshaft of a motor in particular for a rheometer for measuring viscosity of a sample.

In this case, significant improvements arise when using large signal amplitudes, in which the medium to be examined or the sample to be examined is operated in the nonlinear force or tension range. In particular, the invention renders it possible to predetermine a very exact sine profile and cosine profile of the torque or of the deflection of the electric motor.

In order to be able to take better account of the frequency dependence of the individual nonlinear effects of the sample, provision can be made for sine torques and cosine torques to be used as a base function.

In order to be able to generate a spectrum of different frequencies in a simple manner, provision can be made for a first base function to have a predetermined basic shape and for the further base functions each to be compressed in relation to the first base function by an integer value, in such a way that fₙ(t)=f₁(n*t).

For the purposes of reducing the required computational time, provision may be made for the number of the selected base functions to be less than 5.

A preferred embodiment of the invention, which enables fast signal adaptation in real time, provides for the base functions to be predetermined as periodic functions and for the sampling to be selected in such a way that more than one hundred samples are taken during the period duration of the base function with the longest period.

For the same purpose, provision can be made for the base functions to be predetermined periodically and for the time window, within which the samples are undertaken, to have a duration of between 25% and 50% of the period duration of the base function with the longest period.

The adaptation, as described in steps h) to k) is preferably undertaken multiple times in order to obtain good correlation between the intended signal and the actual signal. To this end, provision can advantageously be made for the base functions to be predetermined as periodic functions and for the adaptation of steps h) to k) to be repeated periodically, wherein a time period of between 25% and 100% of the period duration of the base function with the longest period lies between two adaptations in each case.

Other features which are considered as characteristic for the invention are set forth in the appended claims.

Although the invention is illustrated and described herein as embodied in a method for actuating an electric motor and a configuration for exerting oscillatory rotation of a driveshaft, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of a particularly preferred embodiment of the invention showing a motor to which a predetermined voltage profile or current profile is applied by a regulator by way of a voltage source as well as a sample to which drive energy is transferred;

FIG. 2 is a diagram showing an advantageous example of base functions;

FIG. 3 is a diagram showing a measured variable; and

FIG. 4 is a graph of an intended parameter vector against deflection.

### DETAILED DESCRIPTION OF THE INVENTION

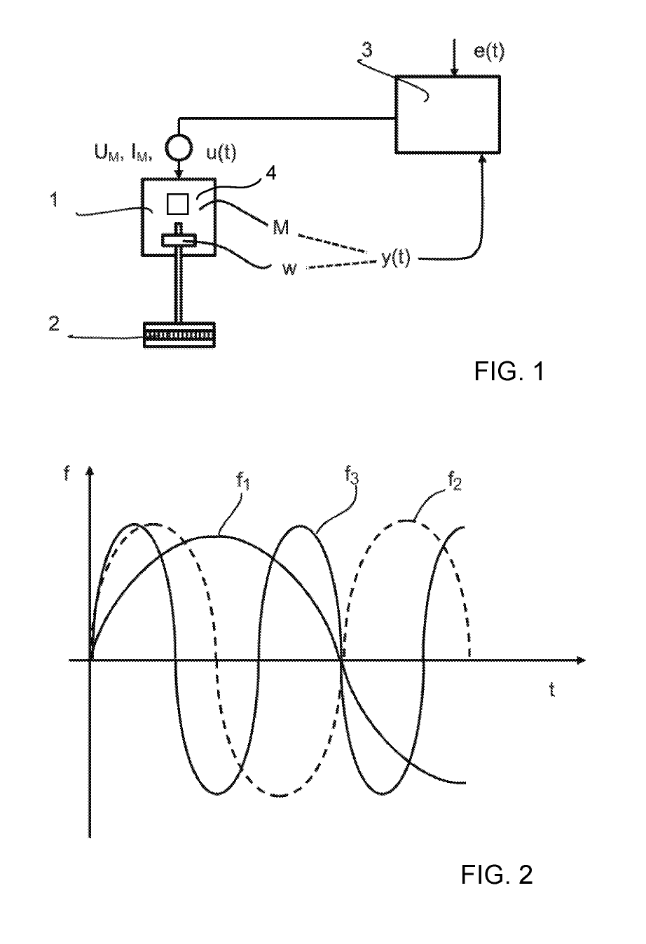

Referring now to the figures of the drawings in detail and first, particularly, to FIG. 1 thereof, there is seen a motor 1 to which a predetermined voltage profile U_{M} or current profile I_{M} is applied by a regulator 3 by way of a voltage source. In a manner dependent on a predetermined intended time profile for a deflection w of the motor or for a sample torque M, the regulator 3 accordingly sets a current time profile or a voltage time profile as a manipulated variable u(t). The electric motor 1 is actuated for an oscillatory rotation of the driveshaft thereof. The electric motor 1 transfers a drive energy thereof onto a sample 2 through a motor shaft. The sample 2 is situated between two plates, of which at least one is rotated counter to the sample 2 in such a way that, overall, the sample 2 is subjected to a shearing or rotational movement. Different torques arise on the motor shaft depending on the deflection of the driveshaft of the electric motor 1 due to the specific viscosity of the sample 2. These established or set deflections w and torques M can be related to one another, as a result of which the specific viscoelastic behavior of the sample 2 to be examined can be established.

It is either the sample torque M or the deflection w which is predetermined in advance in the form of an intended variable e(t) so that such a measurement can be undertaken overall. In this case, the intended time profile e(t) has a periodic, predetermined form and is predetermined for the regulator 3.

The configuration in FIG. 1 contains a measuring device 4, which continuously determines either the actual value of the deflection w or the actual value of the sample torque M. Ultimately, this measuring device 4 supplies actual values for the deflection w or the sample torque M as measured variable y(t) and transfers the latter to the regulator 3.

The assumption is made within the scope of the invention that the sample 2 exhibits nonlinear behavior. If the driveshaft of the motor 1 is only moved within a small deflection range about a work point, the sample 2 usually has a linear behavior around the relevant work point. However, if the deflection w is increased, this has as a consequence in the case of a nonlinear sample 2 that the measured variables y(t) and the manipulated variable u(t) behave nonlinearly in relation to one another, at least within a range between the maximum and minimum of the predetermined, periodic intended time profile e(t). Due to this nonlinear behavior, it is not possible either to already estimate or establish a manipulated variable u(t), which ultimately obtains the desired intended time profile e(t), in advance. Moreover, the problem of a sample 2 changing during the measurement, in particular having a behavior exhibiting hysteresis, may also arise, and so setting a manipulated variable u(t) in advance for the purposes of reaching a predetermined intended time profile e(t) is not possible. It is for this reason that the invention uses the iterative method described in more detail below, in which the predetermined intended time profile e(t) for the deflection w or the sample torque M is ultimately achieved in a simple manner.

Initially, that is to stay still before the iterative adjustment, an approximation function e′(t) is established for the intended time profile e(t), which approximation function is established as weighted sum of a number of predetermined, periodic base functions f₁(t), f₂(t), . . . which may be offset in time when necessary.

Advantageously, sine or cosine oscillations f₁(t)=sin(a₀t), f₂(t)=sin(2a₀t), . . . are used as base functions f₁(t), f₂(t), . . . , where a₀ represents a base frequency of in particular 1 Hz, and the first base function f₁(t) has a predetermined basic shape and the further base functions are in each case compressed in relation to the first base function by a predetermined integer value in such a way that fₙ(t)=f₁(n*t). Preferably, use is only made of a few base functions in total. The present exemplary embodiment uses only three base functions in total.

By way of example, an advantageous example for base functions is depicted in more detail in FIG. 2. If the intended time profile e(t) is intended to be represented by an approximation function e′(t), it is necessary to establish the individual weights, by using which the base functions f₁(t), f₂(t), . . . are intended to be weighted, in order to ultimately arrive at a time profile which corresponds to the intended time profile e(t) to the best possible extent e(t)˜e′(t)=e₁f₁(t)+e₂f₂(t)+ . . . . The weights e₁, e₂, . . . established thus are established as an intended parameter vector E=[e₁, e₂, . . . ] and kept available for the further procedure. To the extent that use is made of sine and cosine oscillations, the values of the intended parameter vector E may be established e.g. by using a discrete Fourier transform or a Fast Fourier Transform (FFT).

For the purposes of initially setting the manipulated variable u(t), a manipulated parameter vector U=[u₁, u₂, . . . ] is predetermined, the individual elements of which represent weights which—multiplied by the base functions—approximately reproduce the manipulated variable u(t) as a weighted sum.

u(t)˜u′(t)=u₁f₁(t)+u₂f₂(t)+ . . .

The intended parameter vector E, multiplied by a predetermined factor x, is predetermined as an initial value for the manipulated parameter vector U. The predetermined factor x is set in advance as follows: 0.5 if M is predetermined and 0.5*J*(2*pi*fₙ)² if w is predetermined (J: inertia of the measurement drive).

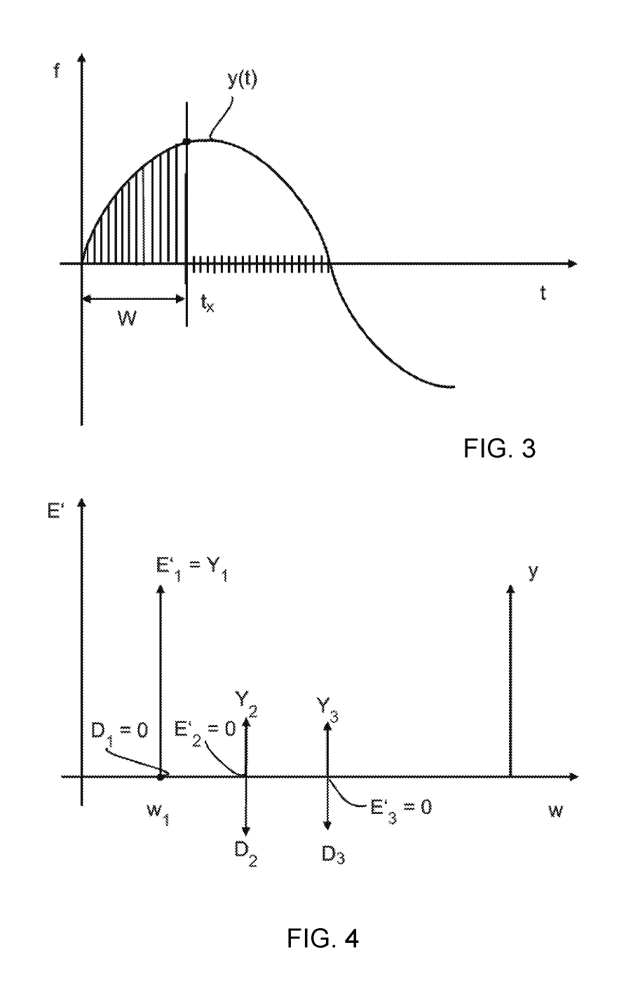

An iterative method is now presented below, by using which the regulator 3 continuously adapts the manipulated variable u(t) in order to generate a deflection w or a sample torque M in accordance with the predetermined intended time profile e(t). As is depicted in FIG. 3, the measured variable y(t)—either the deflection w or the sample torque M—is sampled to this end. Advantageously, sampling takes place at very short intervals, wherein, in relation to the period duration of the base function f₁(t) with the respective longest period, more than 100 samples are taken during such a period duration. In the case of a period duration of the base function f₁(t) of 1000 ms, the sampling rate is preferably 512 Hz. Preferably, between 256 and 512 sampled values, in particular 256 or 512 sampled values, are recorded per oscillation. The sampled values within a time window W, which immediately precedes the respectively current time, are used. The time window W, within which the samples are used, is e.g. set to a duration of between 25% and 100% of the period duration of the base function f₁(t) with the longest period.

Subsequently, the sampled values of the measured variable y(t) within the time window W are also subjected to the same analysis as the intended time profile. An approximation function y′(t) is established as a weighted sum of the base functions; the individual weights, thus established, for the individual base functions are combined to form an actual parameter vector Y.

y(t)˜y′(t)=y₁f₁(t)+y₂f₂(t)+ . . . ; Y=[y₁, y₂, . . . ]

A difference D between the intended parameter vector E and the actual parameter vector Y is established in a further step. This difference D seen in FIG. 4 is weighted by a predetermined factor v, which, in particular, lies between 0.2 and 0.5. This difference D is subtracted from the manipulated parameter Uₙ and the manipulated parameter Uₙ₊₁ for the next iteration step is thus formed.

Uₙ₊₁:=Uₙ−D=Uₙ−(E−Y)*v

In a last step, the manipulated variable u(t) for the next iteration step is established as a weighted sum of the base functions on the basis of the newly established manipulated parameter vector Uₙ₊₁.u(t)=u₁f₁(t)+u₂f₂(t). Subsequently, sampling is once again carried out within a subsequent time window W, an actual parameter vector Y is once again established, the difference D is established between the intended parameter vector E and the actual parameter vector Y and that difference is subtracted from the manipulated parameter vector U, and the manipulated parameter vector U is once again used for generating the manipulated variable u(t). This process is undertaken continuously by the regulator 3 in order to achieve appropriate adaptation to the measured variable, i.e. the deflection w or the sample torque M.

The adaptation can be repeated as often as desired. There is a time period between two respectively adaptations in each case of between 25 and 100% of the period duration of the base function f₁(t) with the longest period.

1. A method for actuating an electric motor for an oscillatory rotation of a driveshaft of the electric motor or a driveshaft of a rheometer, the method comprising the following steps:
a) using the electric motor to transfer drive energy of the electric motor to a sample resisting oscillation of the electric motor;
b) predetermining an intended time profile to be achieved for a deflection or for a sample torque and providing the intended time profile with a periodic predetermined form;
c) continuously establishing an actual value for the deflection or for the sample torque as a measured variable;
d) actuating the electric motor by predetermining a manipulated variable in a form of a voltage applied to the electric motor or a current flowing through electric motor;
e) the measured variable and the manipulated variable behaving nonlinearly with respect to one another, at least within a region between a maximum and a minimum of the predetermined periodic intended time profile;
f) establishing an approximation function for the intended time profile as a weighted sum of a number of predetermined periodic base functions with a time offset where necessary, and establishing weights being used for individual base functions as an intended parameter vector;
g) predetermining the manipulated variable as a sum of the base functions weighted by manipulated parameters of a manipulated parameter vector, and initially predetermining the intended parameter vector multiplied by a predetermined factor as manipulated parameter vector;
subsequently carrying out the following steps h) to k) continuously and repeatedly in accordance with a regulating process, as follows:
h) continuously sampling the measured variable and using last established sampled values for the measured variable within a predetermined time window;
i) establishing an approximation function for the sampled values of the measured variable within the time window as a weighted sum of the base functions, and establishing weights being used for the individual base functions as an actual parameter vector;
j) establishing a difference between the intended parameter vector and the actual parameter vector and subtracting the difference, possibly weighted by a further predetermined factor, from the manipulated parameter vector; and
k) predetermining the subsequently used manipulated variable as a weighted sum of the base functions, and using the values of newly generated manipulated parameter vector as weights in steps h) to j).

2. The method according to claim 1, which further comprises at least one of:
using sine and cosine oscillations as the base functions, or
providing a first base function (f₁(t)) with a predetermined basic shape and compressing each of further base functions (f₂(t), . . . ) in relation to the first base function f₁(t) by a predetermined integer value n, in such a way that fₙ(t)=f₁(n*t); or
setting a number of base functions to be less than 5.

3. The method according to claim 1, which further comprises:
predetermining the base functions as periodic functions; and
selecting the sampling in such a way that more than 100 samples are taken during a period duration of a base function with a longest period.

4. The method according to claim 1, which further comprises:
predetermining the base functions periodically; and
providing the time window, within which samples are used, with a duration of between 25% and 100% of a period duration of the base function with a longest period.

5. The method according to claim 1, which further comprises:
predetermining the base functions as periodic functions; and
periodically repeating adaptation of steps h) to k), wherein a time period of between 25% and 100% of a period duration of the base function with a longest period lies between two adaptations in each case.

6. A configuration for exerting oscillatory rotation of a driveshaft of a motor or a driveshaft of a rheometer for measuring viscosity of a sample, the configuration comprising:
a) an electric motor including a driveshaft for transferring drive energy of said electric motor to the sample;
b) a motor regulator having a periodic intended time profile to be achieved, being predetermined in advance for a deflection or for a sample torque;
c) a measuring device continuously establishing an actual value for the deflection or for the sample torque as a measured variable and reporting said measured variable to said regulator;
d) said regulator actuating said electric motor by predetermining a manipulated variable in a form of a voltage applied to said electric motor or a current flowing through said electric motor;
e) said measured variable and said manipulated variable behaving nonlinearly with respect to one another, at least within a region between a maximum and a minimum of said predetermined periodic intended time profile;
f) said regulator establishing an approximation function for said intended time profile as a weighted sum of a number of predetermined periodic base functions, with a time offset where necessary, and establishing weights being used for individual base functions as an intended parameter vector;
g) said regulator predetermining said manipulated variable as a sum of said base functions weighted by manipulated parameters of a manipulated parameter vector, and initially predetermining said intended parameter vector multiplied by a predetermined factor as a manipulated parameter vector; and
said regulator subsequently performing the following functions h) to k) in accordance with a regulating process in a continuous and repeated manner, as follows:
h) said regulator continuously sampling said measured variable from said measuring device and using last established sampled values for said measured variable within a predetermined time window;
i) said regulator establishing an approximation function for said sampled values of said measured variable within said time window as a weighted sum of said base functions, and establishing weights being used for said individual base functions as an actual parameter vector;
j) said regulator establishing a difference between said intended parameter vector and said actual parameter vector and said regulator subtracting said difference, possibly weighted by a further predetermined factor, from said manipulated parameter vector; and
k) said regulator predetermining a subsequently used manipulated variable as a weighted sum of said base functions, and said regulator using values of a newly generated manipulated parameter vector as weights in said functions h) to j).

7. The configuration according to claim 6, wherein at least one of:
sine and cosine oscillations are used as said base functions, or
a first base function (f₁(t)) has a predetermined basic shape and further base functions (f₂(t), . . . ) are each compressed in relation to said first base function f₁(t) by a predetermined integer value n, in such a way that fₙ(t)=f₁(n*t), or
said base functions have a number less than 5.

8. The configuration according to claim 6, wherein:
said base functions are predetermined as periodic functions; and
said sampling is selected in such a way that more than 100 samples are taken during a period duration of said base function with a longest period.

9. The configuration according to claim 6, wherein:
said base functions are periodic; and
said time window, within which said samples are used, has a duration of between 25% and 100% of a period duration of said base function with a longest period.

10. The configuration according to claim 6, wherein:
said base functions are periodic; and
said regulator periodically repeats an adaptation of functions h) to k), and a time period of between 25% and 100% of a period duration of said base function with a longest period lies between two adaptations in each case.
